(19) United States
(12) Patent Application Publication
(10) Pub. No.: US 2010/0323194 A1
(43) Pub. Date: Dec. 23, 2010

(54) VIBRATION DAMPER AND VIBRATION DAMPING STRUCTURE

(76) Inventors: Yoshifumi Matsuda, Kyoto (JP); Hiroyuki Abe, Kyoto (JP); Takashi Oguchi, Kyoto (JP)

Correspondence Address: JACOBSON HOLMAN PLLC, 400 SEVENTH STREET N.W., SUITE 600, WASHINGTON, DC, 20004, US

(21) Appl. No.: 12/448,428

(22) PCT Filed: Nov. 8, 2007
(86) PCT No.: PCT/JP2007/071724

§ 371 Date: Jun. 19, 2009

(30) Foreign Application Priority Data
Feb. 9, 2007 (JP) 2007-030499

(51) Int. Cl. B32B 5/00

(52) U.S. Cl. 428/340

(57) ABSTRACT

The present invention provides a vibration damper comprising a constrained layer and a resin layer, wherein the constrained layer is constituted of an inorganic material, an organic mass of the resin layer is 1.0 kg/m² or less, and the resin layer is constituted of a resin composition comprising 100 parts by weight of a chlorine-containing thermoplastic resin having a chlorine content of 20 to 70 wt % and a weight average molecular weight of 400,000 or more, and 200 to 1,000 parts by weight of a chlorinated paraffin having an average carbon atom number of 12 to 50 and a degree of chlorination of 30 to 75 wt %.

### TECHNICAL FIELD

The present invention relates to a vibration damper, and preferably a marine vibration damper and a vibration damping structure. More particularly, it relates to a vibration damper and a vibration damping structure, having excellent vibration damping performance and fireproof performance.

### BACKGROUND ART

Conventionally, a method of overpainting a coating-type vibration damper such as an epoxy resin-based vibration damper on walls, floors and ceilings of engine rooms, resident rooms and the like has been employed to ensure vibration damping properties of ships. However, it is necessary to take drying time during overpainting. This required long working time, resulting in increase of working cost.

Furthermore, to ensure fireproof performance in addition to vibration damping performance in ships, there is the case that treatment for further imparting fireproof performance to the surface of a coating-type vibration damper is required. For example, Patent Document 1 proposes that a glass fiber fireproof layer and a metal film fireproof layer are provided on the outer surface of an epoxy vibration damper applied to a structure or equipment of a ship.

Furthermore, Patent Document 2 proposes a structure that a vibration damper comprising a viscoelastic material, and a steel plate are sandwiched between a floor steel plate and a deck composition layer, wherein the vibration damper and the steel plate, and the steel plate and the deck composition layer, are adhered through an adhesive layer.

### Patent Document 1: JP-A-2005-205816

### Patent Document 2: JP-UM(Utility Model)-A-5-037678

### DISCLOSURE OF THE INVENTION

### Problems that the Invention is to Solve

In general, paint application in ships is conducted by directly applying a paint by hand working. Therefore, coating work is complicated, and furthermore, finish may be poor depending on the level of skill of workers. Additionally, there is a possibility that a paint makes foul surrounding materials other than working objects during working.

Furthermore, the thickness of the finished coating film is increased, and this gives rise to the problem that space of rooms and piping space under the roof are decreased by just that much.

The present invention has an object to provide fresh vibration damping and fireproof means that can solve the above various problems due to paint application.

### Means for Solving the Problems

The present inventors have found that a vibration damper comprising a constrained layer and a resin layer, wherein an organic mass of the resin layer is a predetermined value or less can provide a vibration damper and a vibration damping structure, having excellent vibration damping performance and fireproof performance, without involving various problems due to paint application, and have completed the present invention.

A first invention is a vibration damper comprising a constrained layer and a resin layer, wherein the constrained layer is constituted of an inorganic material, an organic mass of the resin layer is 1.0 kg/m² or less, and the resin layer is constituted of a resin composition comprising 100 parts by weight of a chlorine-containing thermoplastic resin having a chlorine content of 20 to 70 wt % and a weight average molecular weight of 400,000 or more, and 200 to 1,000 parts by weight of a chlorinated paraffin having an average carbon atom number of 12 to 50 and a degree of chlorination of 30 to 75 wt %.

The vibration damper of the first invention is preferably used in ships. The organic mass of the resin layer is preferably 0.6 kg/m² or less.

A second invention is a vibration damping structure which comprises a vibration damper comprising a constrained layer and a resin layer, in which a constituent material, the vibration damper are adhered at the resin layer side thereof to at least a part of the constituent material as an adherend, wherein the constrained layer is constituted of an inorganic material, an organic mass of the resin layer is 1.0 kg/m² or less, loss factor in a state that the vibration damper is adhered to an adherend is 0.1 or more, and the resin layer is constituted of a resin composition comprising 100 parts by weight of a chlorine-containing thermoplastic resin having a chlorine content of 20 to 70 wt % and a weight average molecular weight of 400,000 or more, and 200 to 1,000 parts by weight of a chlorinated paraffin having an average carbon atom number of 12 to 50 and a degree of chlorination of 30 to 75 wt %.

The vibration damping structure of the second invention is preferably used in ships. The organic mass of the resin layer is preferably 0.6 kg/m² or less.

A third invention is a vibration damping structure of ships, which comprises a vibration damper comprising a constrained layer and a resin layer, sandwiched between a deck composition layer at the constrained layer side of the vibration damper and a floor steel plate at the resin layer side of the vibration damper, wherein the constrained layer is constituted of an inorganic material, an organic mass of the resin layer is 1.0 kg/m² or less, loss factor in the sandwiched state is 0.1 or more, and the resin layer is constituted of a resin composition comprising 100 parts by weight of a chlorine-containing thermoplastic resin having a chlorine content of 20 to 70 wt % and a weight average molecular weight of 400,000 or more, and 200 to 1,000 parts by weight of a chlorinated paraffin having an average carbon atom number of 12 to 50 and a degree of chlorination of 30 to 75 wt %.

In the vibration damping structure of the third invention, the organic mass of the resin layer is preferably 0.6 kg/m² or less.

The constrained layer constituting the vibration damper according to the present invention can be any layer so long as it is constituted of an inorganic material, and the material is steel plates, stainless steels, aluminum, gypsum, concretes and the like, and is not particularly limited. Steel plates having high elastic modulus are desirable for the improvement of vibration damping property.

The thickness of the constrained material is not particularly limited. However, it is desired that the thickness is 10% or more of the thickness of an adherent to achieve that loss factor in a state that the vibration damper is provided on, for example, a constituent material of ships is 0.1 or more.

Surface coating may be applied to the constrained material. The paints are acrylic resin paints, polyester resin paints, silicon resin paints, amino-alkyd resin paints, vinyl chloride resin paints, fluorine resin paints, epoxy resin paints, urethane resin paints, and the like, and are not particularly limited. The weight of the paint is not particularly limited, but the amount that the organic mass is 65 g/m² or less in one surface is desired.

The materials of the resin layer constituting the vibration damper according to the present invention are rubber types, plastic types, asphalt types and the like, and are not particularly limited. However, for the required fireproof performance, the organic mass is 1.0 kg/m² or less, and preferably 0.6 kg/m² or less. Furthermore, to maintain the performance as the vibration damper, it is desired that the organic mass is 0.2 kg/m² or more.

Throughout the claims and the description, the term “organic mass” means a composition having C—H bond in the composition constituting the resin layer, and can be measured by ignition loss measured by ignition loss test of JIS K0067 “Loss of chemical product, and residue test method”. Furthermore, the deck composition means a mixture comprising sand, water, cement and rubber liquid.

To achieve in the second invention that the loss factor is 0.1 or more in the state that the vibration damper is provided on an adherent as a constituent material (preferably a constituent material of ship) and to achieve in the third invention that the loss factor is 0.1 or more in the state that the vibration damper is sandwiched between the deck composition layer at the constrained layer side and the floor steel plate at the resin layer side, it is desired that the resin layer is constituted of a resin composition comprising 100 parts by weight of a chlorine-containing thermoplastic resin having a chlorine content of 20 to 70 wt % and a weight average molecular weight of 400,000 or more, and 200 to 1,000 parts by weight of a chlorinated paraffin having an average carbon atom number of to 50 and a degree of chlorination of 30 to 75 wt % (particularly, a chlorinated paraffin in which a chlorinated paraffin having a degree of chlorination of 70 wt % or more occupies 10 to 70 wt %). As such a resin layer, a product obtained by kneading 100 parts by weight of a chlorinated polyethylene obtained by post-chlorinating a high density polyethylene by a water suspension method, 400 parts by weight of a chlorinated paraffin (chlorine content: 50 wt %, number average carbon number: 14) and 400 parts by weight of calcium carbonate at 120° C. using a roll kneader, and pressing the resin mixture obtained at 140° C. to mold into a sheet having a thickness of 1.0 mm is preferably used.

On a floor of general resident room and the like, a layer comprising a deck composition is provided on a floor steel plate. When the vibration damper according to the present invention is used, the vibration damper is provided on a floor deck, and a deck composition is provided thereon. By this, the deck composition serves the function of the constrained layer, and it is possible to further improve vibration damping performance of the vibration damper. Furthermore, the floor can be finished as the same as the general floor in appearance. The vibration damper of the present invention has the performance to pass The International Maritime Organization (IMO), Marine Safety Committee Resolution 61(67) “International code for application of fire test procedures”, Part 6 “Test for primary deck coverings” (IMO General Meeting, Resolution A.653(17), and therefore can be provided on a deck. The deck composition is not particularly limited. For the improvement of leveling and vibration damping property, about 6 to 12 mm is desired.

The adherend in the present invention preferably constitutes a part of ship, and examples thereof include walls, floors, ceilings and interior panels of engine rooms and resident rooms, water tanks, stairs, air conditioning piping, and electronic controllers involving problems due to vibration in ships. The vibration damping structure according to the present invention is constituted by adhering the resin layer of the vibration damper of the present invention to those given portions. In particular, the interior panel generally has the structure that an acoustic absorbent such as glass wool or wool rock is sandwiched between thin steel plates (thickness: about 0.6 to 1.0 mm). Therefore, it is possible to provide an interior panel having excellent sound insulating properties by adhering the vibration damper of the present invention to the thin steel plate.

### ADVANTAGE OF THE INVENTION

The vibration damping structure according to the present invention is that the vibration damper comprising a constrained layer and a resin layer is provided on, for example, a constituent material of ship. Therefore, excellent vibration damping performance and excellent fireproof performance can be exhibited in combination without using a paint al all. As a result, all of the problems due to paint application, that coating work is complicated because a paint is directly applied by hand working, and additionally, the finish becomes poor depending of the level of skill of a worker can be solved.

Furthermore, the vibration damper according to the present invention has the performance to pass The International Maritime Organization (IMO), Marine Safety Committee Resolution 61(67) “International code for application of fire test procedures”, Part 5 “Test for surface flammability” (IMO General Meeting Resolution A.653(16) “Test procedures for surface flammability of bulkhead, ceiling and deck finishing materials”, and therefore has fireproof performance that the vibration damper can be used as not only for primary deck coverings (that is, qualified materials as a flooring), but also for flame-retardant facing materials (that is, qualified materials as wall surface materials and ceiling surface materials) in one kind of product specification.

### BEST MODE FOR CARRYING OUT THE INVENTION

To specifically explain the present invention, Examples of the present invention and Comparative Example for comparing with those are described below.

### Examples 1 to 3 and Comparative Example 1

The following materials were provided.

Substrate: Steel plate (thickness: 6 mm)

Constrained layer: Color steel plate (thickness: 0.4 to 1.2 mm)

Resin layer: A product obtained by kneading 100 parts by weight of a chlorinated polyethylene (weight average molecular weight: 500,000, chlorine content: 40 wt %, crystallinity measured by DSC method: 10 J/g) obtained by post-chlorinating a high density polyethylene by a water suspension method, 400 parts by weight of a chlorinated paraffin (a product of Ajinomoto Fine Chemical Co., trade name: Empara K50, chlorine content: 50 wt %, number average carbon number: 14) and 400 parts by weight of calcium carbonate (a product of Maruo Calcium Co., Ltd., trade name: R Ground Calcium Carbonate) at 120° C. using a roll kneader, and pressing the resin mixture obtained at 140° C. to mold into a sheet (thickness: 0.5 mm, organic mass: 0.6 kg/m²).

As shown in FIG. 1, a vibration damper (1) comprising a constrained layer (3) and a resin layer (2) was provided on a substrate (4) such that the resin layer (2) contacts the substrate (4).

### Examples 4 to 6

The following materials were provided.

Substrate: Steel plate (thickness: 6 mm)

Constrained layer: Color steel plate (thickness: 0.4 to 1.2 mm)

Resin layer: A product obtained by kneading 100 parts by weight of a chlorinated polyethylene (weight average molecular weight: 500,000, chlorine content: 40 wt %, crystallinity measured by DSC method: 10 J/g) obtained by post-chlorinating a high density polyethylene by a water suspension method, 400 parts by weight of a chlorinated paraffin (a product of Ajinomoto Fine Chemical Co., trade name: Empara K50, chlorine content: 50 wt %, number average carbon number: 14) and 300 parts by weight of calcium carbonate (a product of Maruo Calcium Co., Ltd., trade name: R Ground Calcium Carbonate) at 120° C. using a roll kneader, and pressing the resin mixture obtained at 140° C. to mold into a sheet (thickness: 0.5 mm, organic mass: 0.6 kg/m²).

Deck composition layer: A product obtained by mixing given amounts of sand, water, cement and rubber liquid (thickness: 6-12 mm).

As shown in FIG. 2, a vibration damper (1) comprising a constrained layer (3) and a resin layer (2) was provided on a substrate (5) such that the resin layer (2) contacts the substrate (5), and a deck composition layer (6) was provided thereon.

### Evaluation Test

The following evaluation tests were conducted to the structures of Examples 1 to 6 and Comparative Example 1.

### a) Loss Test

Test procedure: According to JIS G0602 “Test methods for vibration-damping property in laminated damping steel sheets of constrained type”

### b) Fire Safety Test

Test procedure: According to The International Maritime Organization (IMO), Marine Safety Committee Resolution 61(67) “International code for application of fire test procedures”, Part 5 “Test for surface flammability” and IMO General Meeting Resolution A.653(16) “Test procedures for surface flammability of bulkhead, ceiling and deck finishing materials”

Test results are shown in Table 1 together with constitution of a vibration damper.

TABLE 1

| | Constrained | Resin layer | | |
|---|---|---|---|---|
| | layer | Length (mm)/ | | |
| | Thickness | organic mass | | Fire safety |
| | (mm) | (kg/m²) | Loss factor | test |
| Example 1 | 1.2 | 0.5/0.6 | 0.16 | Pass |
| Example 2 | 0.8 | 0.5/0.6 | 0.1 | Pass |
| Example 3 | 0.4 | 0.5/0.6 | 0.08 | Pass |
| Example 4 | 1.2 | 0.5/0.6 | 0.2 | Pass |
| Example 5 | 0.8 | 0.5/0.6 | 0.14 | Pass |
| Example 6 | 0.4 | 0.5/0.6 | 0.12 | Pass |
| Comparative | 0.8 | 1.0/1.2 | 0.11 | Not pass |
| Example 1 | | | | |

As is apparent from Table 1, the vibration damping structure according to the present invention shows excellent loss factor and passes the fire safety test.

### BRIEF DESCRIPTION OF THE DRAWINGS

FIG. 1 is a cross-sectional view showing a vibration damping structure constituted in Examples 1 to 3 and Comparative Example 1.

FIG. 2 is a cross-sectional view showing a vibration damping structure constituted in Examples 4 to 6.

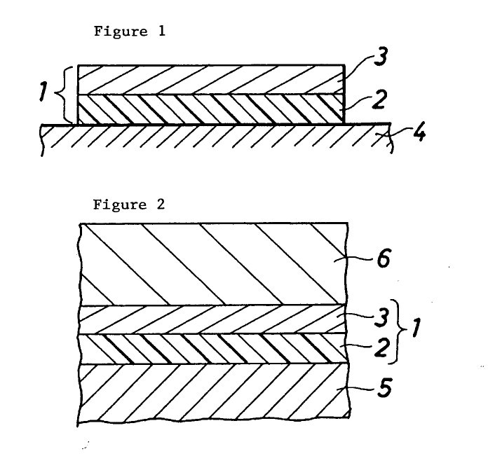

### DESCRIPTION OF REFERENCE NUMERALS AND SIGNS

(1) Vibration damper
(2) Resin layer
(3) Constrained layer
(4) Substrate
(5) Substrate
(6) Deck composition layer

1. A vibration damper comprising a constrained layer and a resin layer, wherein the constrained layer is constituted of an inorganic material, an organic mass of the resin layer is 1.0 kg/m² or less, and the resin layer is constituted of a resin composition comprising 100 parts by weight of a chlorine-containing thermoplastic resin having a chlorine content of 20 to 70 wt % and a weight average molecular weight of 400,000 or more, and 200 to 1,000 parts by weight of a chlorinated paraffin having an average carbon atom number of 12 to 50 and a degree of chlorination of 30 to 75 wt %.

2. The vibration damper as claimed in claim 1, which is used in ships.

3. A vibration damping structure which comprises a vibration damper comprising a constrained layer and a resin layer, in which a constituent material, the vibration damper are adhered at the resin layer side thereof to at least a part of the constituent material as an adherend, wherein the constrained layer is constituted of an inorganic material, an organic mass of the resin layer is 1.0 kg/m² or less, a loss factor in a state that the vibration damper is adhered to an adherend is 0.1 or more, and the resin layer is constituted of a resin composition comprising 100 parts by weight of a chlorine-containing thermoplastic resin having a chlorine content of 20 to 70 wt % and a weight average molecular weight of 400,000 or more, and 200 to 1,000 parts by weight of a chlorinated paraffin having an average carbon atom number of 12 to 50 and a degree of chlorination of 30 to 75 wt %.

4. The vibration damping structure as claimed in claim 3, which is used in ships.

5. A vibration damping structure of ships, which comprises a vibration damper comprising a constrained layer and a resin layer, sandwiched between a deck composition layer at the constrained layer side of the vibration damper and a floor steel plate at the resin layer side of the vibration damper, wherein the constrained layer is constituted of an inorganic material, an organic mass of the resin layer is 1.0 kg/m² or less, a loss factor in the sandwiched state is 0.1 or more, and the resin layer is constituted of a resin composition comprising 100 parts by weight of a chlorine-containing thermoplastic resin having a chlorine content of 20 to 70 wt % and a weight average molecular weight of 400,000 or more, and 200 to 1,000 parts by weight of a chlorinated paraffin having an average carbon atom number of 12 to 50 and a degree of chlorination of 30 to 75 wt %.
